(19) United States
(12) Patent Application Publication
(10) Pub. No.: US 2004/0178625 A1
(43) Pub. Date: Sep. 16, 2004

(54) Card-format data medium, method for the manufacture of such a data medium and lamination device for the manufacture of a card-format data medium

(75) Inventors: Christof Siegfried, Granichen (CH); Paul Christen, Aarau (CH)

Correspondence Address: William H. Logsdon, WEBB ZIESENHEIM LOGSDON ORKIN & HANSON, P.C., 700 Koppers Building, 436 Seventh Avenue, Pittsburgh, PA, 15219-1818, US

(73) Assignee: TRUB AG, Aarau (CH)

(21) Appl. No.: 10/413,411

(22) Filed: Apr. 14, 2003

(30) Foreign Application Priority Data
Mar. 14, 2003 (EP) 03 405 179.7

(51) Int. Cl. G09C 3/00

(52) U.S. Cl. 283/74

(57) ABSTRACT

The card-format data medium (1, 1′) has a substrate (S) with an upper and a lower surface (10, 11) and an encircling edge (10a). A transparent protection layer (6) and a security film (5) are applied to the top surface (10) of the substrate (S). The security film (5) is positioned within the top surface (10) of the substrate (S) and the transparent protection layer (6) projects beyond the security film (5) all the way around. In at least one peripheral area (6a, 6a′), the protection layer (6) is bonded directly to the substrate (S) over a wide area. The data medium (1, 1′) is particularly resistant to environmental factors and secure against tampering and counterfeiting.

This invention relates to a card-format data medium with a substrate which has an upper surface with printing for optical personalization and an encircling narrow edge, with at least one transparent protection layer and a security layer that is located under said protection layer, which is applied evenly on the upper surface and which covers the above-mentioned printing. The invention also relates to a method for the manufacture of this data medium and to a lamination device.

Card-format data media of the type described above are used particularly as official and unofficial identification cards, driver's licenses and security cards. Personalization systems have been developed for the personalization of such cards in which a substrate can be personalized by thermal transfer printing or thermal sublimation printing, for example. The printing can contain, among other things, personal information about the holder, for example his or her name, date of birth, a photograph and an identification card number.

On data media of this type, it has become essential to guarantee a high level of protection against tampering and counterfeiting and to ensure that the personalization cannot be altered. It is also essential that the data medium adhere permanently, and particularly that it be resistant to wear and environmental factors. Data media of this type must also have a useful life of several years, even when they are unoccupied to severe wear, and during this time the above mentioned protection against tampering and counterfeiting must be preserved. As protection against counterfeiting and tampering, the personalized area or printing is covered with a security film, for example a commercially available TKO film, and a transparent protective film is then also applied on top of the security film. The security film is very thin and is provided with security elements, for example holograms, and cannot be removed from the substrate without leaving visible marks. Environmental factors and especially the effect of moisture on the data medium are particular problems that affect such data media. In particular, the effects of moisture can cause the loss of full protection of the personalization. It has also been shown that the protection film can come detached, in which case the protection of the personalization can no longer be guaranteed.

The object of the invention is to create a card-format data medium of the type described above that is more effectively protected against tampering and wear, in particular mechanical, chemical and thermal wear, and against aging.

The invention teaches a card-format data medium on which the above mentioned personalization means are located inside an unoccupied edge of the upper surface of the substrate on the substrate, and the transparent security film covers these means inside the unoccupied edge and the transparent protection film is bonded directly to the substrate in the vicinity of the unoccupied edge. The protective layer is therefore bonded directly to the substrate in the vicinity of an encircling edge. Tests have shown that as a result of this direct bonding of the transparent protective film to the substrate, the detachment of the protection layer from the data medium as a result of environmental factors can be prevented more reliably than in similar systems of the prior art. Moisture can no longer penetrate between the layers on the edge of the data medium and separate the safety film so that it comes detached. This system also ensures that the security layer cannot be detached from the substrate if someone attempts to tamper with the card. On one hand, the personalization is thereby better protected against tampering or counterfeiting, and on the other hand the data medium is more effectively protected against damage. Multiple-layer security films can also be used, which would otherwise separate as a result of the penetration of moisture.

Even greater security against counterfeiting and tampering can be achieved if, as described by one development of the invention, the security film consists of several parts which are fastened to the substrate at some distance from one another, so that the transparent protection film is also bonded to the substrate evenly between these parts. The permanence of the adherence is also thereby increased, because the data medium layer cannot come detached from the data medium in the central area. The printing in this case preferably also consists of a plurality of areas, each of which is completely covered by a portion of the safety film.

The peripheral area in which the transparent protection layer is directly bonded to the substrate is preferably a few millimeters wide, and preferably a maximum of approximately 10 mm wide. A sufficiently large area is thereby available for the data for the personalization of the data medium.

In one particularly advantageous method for the manufacture of a card format data medium, the security film is attached to the substrate by means of a roller. A particularly precise positioning of the security film on the substrate can then be guaranteed if the roller applies or laminates the security film on the substrate using a stamping principle. During this process, the security film (security layer) is detached from a backing film.

A particularly advantageous lamination device has a fuser roller which is driven directly. The fuser roller is tapped on the periphery preferably corresponding to the security film to be transferred so that the security film is detached from the backing film according to the stamping principle and is transferred to the substrate. The drive of the fuser roller is thereby synchronized precisely with the movement or speed of the card being manufactured.

In one development of the invention, a registration of the fuser roller ensures that the positioning of the security film to be applied on the upper side of the substrate is identical on all data media. For this purpose, the fuser roller is preferably moved into an idle position after every application.

One exemplary embodiment of the invention is described in greater detail below with reference to the accompanying drawing, in which:

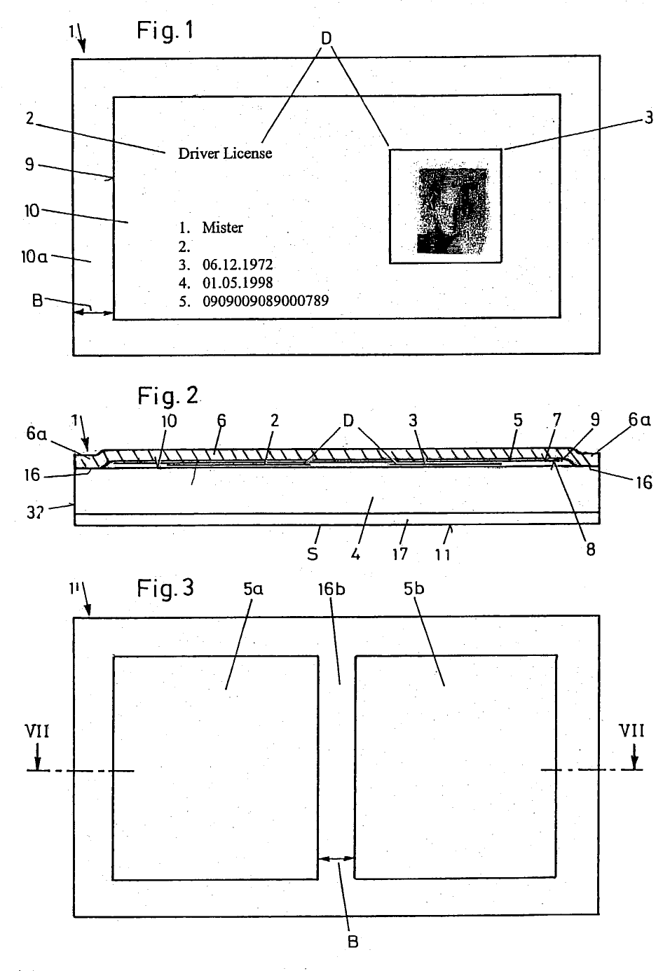

FIG. 1 is a schematic overhead plan view of a data medium as claimed by the invention,

FIG. 2 is a side view of the data medium illustrated in FIG. 1,

FIG. 3 is a schematic overhead plan view of one variant of a data medium,

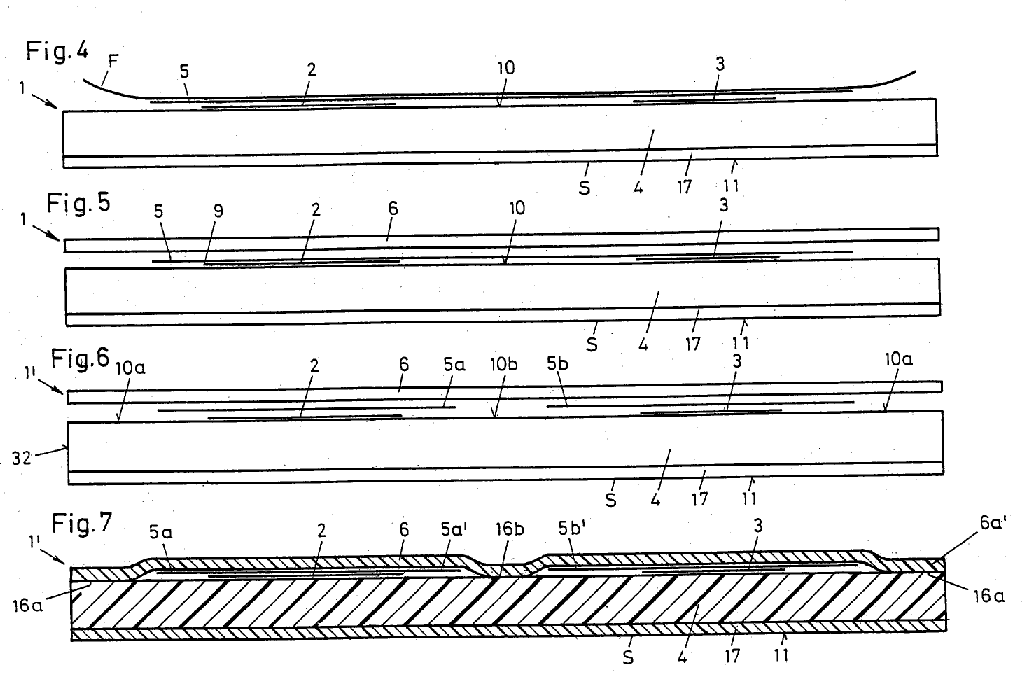

FIG. 4 is a schematic view of the positioning of a data medium layer on the substrate,

FIG. 5 is a schematic view of the application of the cover film,

FIG. 6 is a schematic side view of the data medium illustrated in FIG. 3, whereby the layers are separated from one another to illustrate the structure,

FIG. 7 is a schematic view in section along Line VII-VII in FIG. 3,

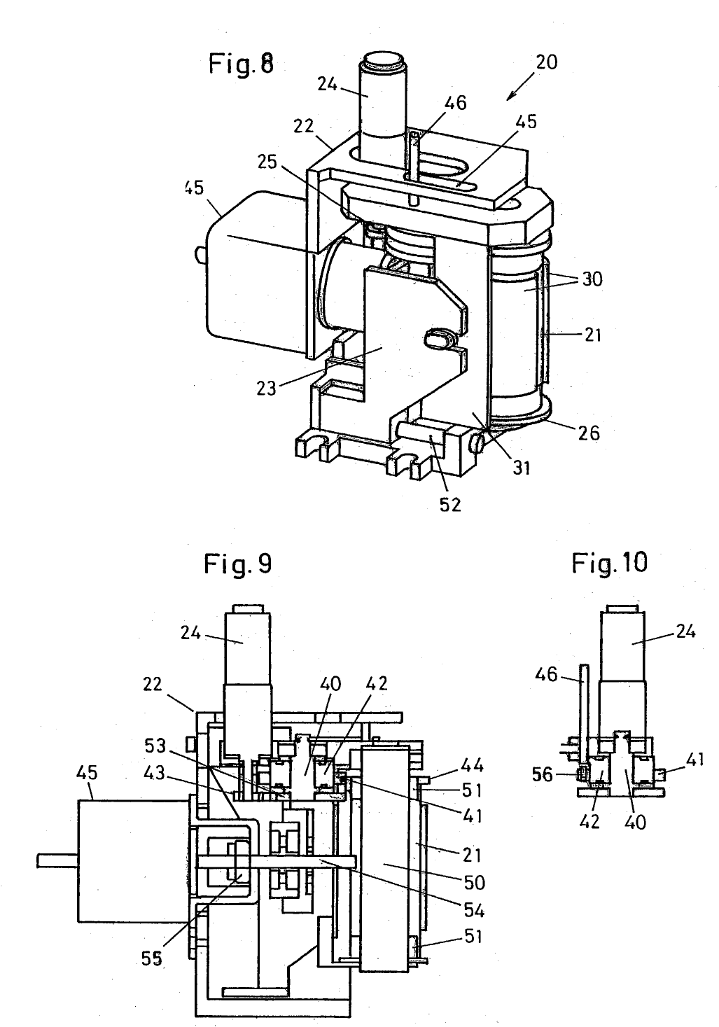

FIG. 8 is a schematic view of a lamination device as claimed by the invention, whereby parts are shown in breakaway for technical reasons,

FIG. 9 is a schematic view in section through a fuser roller,

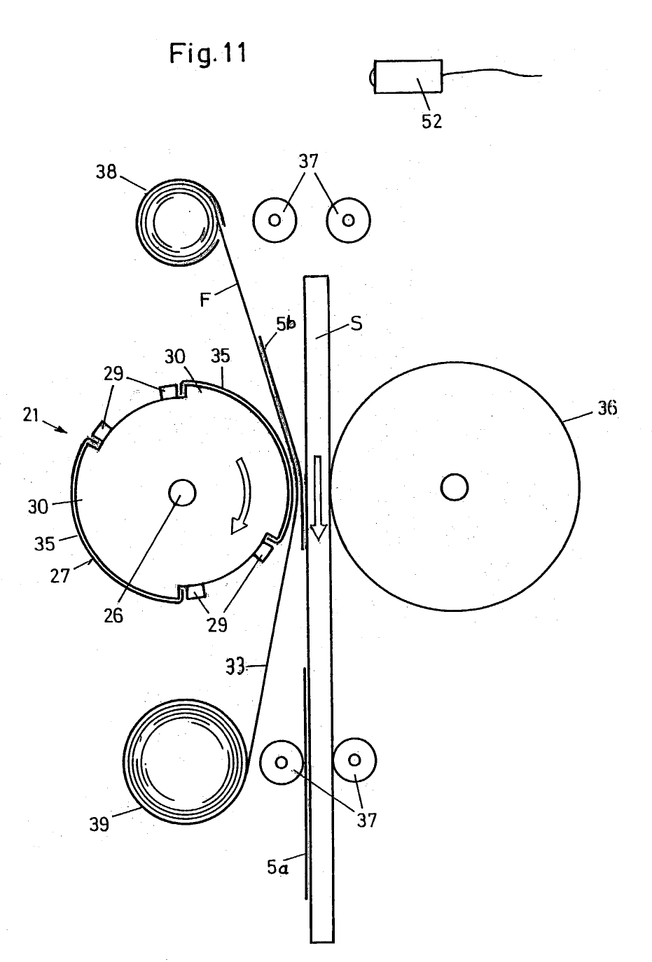

FIG. 10 is a schematic partial view of the lamination device, and

FIG. 11 is a schematic illustration of the lamination of the security film.

FIGS. 1 and 2 show a data medium 1, which is realized in the form of a flexible, laminated, rectangular card. A substrate S preferably consists of a plurality of layers 4. A bottom layer 17 is formed by a transparent protection film. Printing D is applied on a top surface 10 (FIG. 4) of the substrate S. This printing D can be applied to the substrate S, for example, by thermal sublimation or thermal transfer printing, and consists in particular of data 2 and a graphic image 3. The printing D can, for example have a thickness of approximately 2 μm to 5 μm. Basically, an optical personalization by means other than printing is also conceivable.

The printing D is positioned within the surface area 10 and, as shown in FIG. 1, leaves an encircling edge 10a free. The width B of this edge 10a is a maximum of approximately 10 mm and preferably 3 to 8 mm.

To protect the printing D (personalization) against tampering or counterfeiting, the printing is covered with a transparent security film 5, which can be a multiple-layer film. The security film can be in particular a TKO film which is applied mechanically and bonded to the printing D or the substrate S. This very thin security film 5 is equal to or approximately equal to the size of the printed area (the personalization) and also leaves the edge 10a free. The security film 5 is covered by a transparent protection layer 6 which is significantly thicker than the security film 5 and extends approximately to the narrow edge 32 of the substrate S. This protection layer 6 is preferably applied at a distance of approximately 1 to 1.5 mm from the edge. It is also conceivable, however, that this edge can be even narrower or can be eliminated altogether.

The transparent protection layer 6 projects beyond the security film 5 all the way around with a peripheral area 6a which is bonded directly to the substrate layer 4. Between the transparent protection layer 6 and the substrate S, there is thus an encircling bond 16 over a wide area which is created by a lamination process. The bond 16 is preferably an adhesive bond. During the lamination process, a suitable adhesive on the underside of the protection layer 6 is activated by heat. The security film 5 is bonded on its underside 8 and on its upper side 7 over its entire surface to the substrate S and the transparent protection layer 6 respectively. These side-area bonds are also created during the lamination by the activation of an adhesive.

The security film 5 has an encircling edge 9 which is located at some distance from the narrow edge 32 of the data medium 1. The security film 5 is therefore within the upper surface 10 of the substrate S. Because the bond 16 is largely inert to environmental influences and particularly to moisture, the penetration of moisture into the area of the printing 5 and the security film is effectively prevented. The security film 5 can also not separate from the substrate S and from the printing D even as a result of the long-term effects of moisture. The permanent bond 16 also makes it more difficult to separate the protection layer 6 if an attempt is made to tamper with or counterfeit the information on the card.

In the embodiment illustrated in FIG. 3, the security film 5 consists of two parts 5a and 5b, which are positioned at some distance from each other on the substrate layer 4. Between the parts 5a and 5b, there is a strip-shaped area 16b in which the security film 5 is bonded directly with the substrate S. Both parts 5a and 5b are thus covered by the same protection layer 6, which projects beyond them all the way around. The protection layer 6 is thus also bonded in the central portion 16b of the data medium 1′ directly with the substrate layer 4, which is particularly effective in preventing a detachment of the data medium layer 5 in the central portion 16b of the data medium 1′. The width B of the area 16b is preferably also a few millimeters, preferably less than 8 mm. In one conceivable embodiment, the security film 5 can also consist of two or more parts located at some distance from one another.

During the manufacture of the data medium 1, the substrate S is personalized by printing the data 2 and the graphic image 3 on the top surface 10. The printing is done particularly by thermal transfer printing or thermal sublimation printing. Basically, however, other printing technologies, for example laser printing or other methods can also be used to apply visible information.

After the printing of the substrate S, a film strip F is precisely positioned as illustrated in FIG. 4 on the upper surface 10 of the substrate S and applied using a fuser roller 21 to the top surface 10 using the stamping principle as illustrated in FIG. 11. During this process, the security film 5 is separated from a backing film of the film F and transferred to the substrate 4.

After the deposition of the security film 5, the transparent protection layer 6 is laminated on top. On the upper side of the protection layer 6, a step can be formed on the edge 6a, as shown by way of example in FIG. 2.

FIG. 5 shows the substrate S with the security film 5 applied. As shown, the edge 9 is offset inward with respect to the narrow edge 32. If the transparent protection layer 6 is then laminated on, this layer is bonded directly to the substrate S outside the edge 9 in the area 10a.

During the manufacture of the data medium 1′, as shown in FIG. 6, two matching security films 5a′ and 5b′ that are separate from each other are laminated over the substrate S. During the lamination of the transparent protection layer 6, this layer is bonded to the substrate S in an encircling peripheral area 10a and in an intermediate area 10b. FIG. 7 shows the finished data medium 1′ and, as shown, between the transparent protection layer 6 and the substrate S there is an external encircling bond 16a and a bond 16b in a central area. These bonding areas 16a and 16b are bonded to each other in the shape of a figure eight, as shown in FIG. 3. The two security films 5a′ and 5b′ are thus each surrounded by a permanently bonded area 16a and 16b respectively and are thus protected against tampering and the penetration of moisture. The central area 16b also stabilizes the data medium 1′, because in this area, as shown in FIG. 3, the transparent protection layer 6 is bonded to the substrate S particularly solidly. The data medium 1′ is therefore particularly durable, even when unoccupied to sever stresses and strong mechanical loads.

The lamination device 20 provided to apply the security film 5 is illustrated in FIGS. 8, 9 and 10. This lamination device has a machine frame 22 in which a carrier 23 is mounted so that it can be displaced on guide rods 52.

Between side plates 31 which are bonded to the carrier 23, a fuser roller 21 is mounted on the carrier 23, which fuser roller 21 is driven by a servomotor 24 by means of a gear train 25. When the carrier 23 is moved, the fuser roller 21, the gear train 25 and the servomotor 24 are moved simultaneously. An initiator 46 is also moved simultaneously. To make such a simultaneous displacement possible, corresponding slots 45 are worked into the machine frame 22. In FIG. 9, the fuser roller 21 can thus be moved horizontally in the plane of the drawing.

As shown in FIG. 9, the gear train has a stepped shaft 40 which is mounted on the carrier 23 and is connected by means of a freewheel mechanism 42 with a gear wheel 41. A gear wheel 53 which is permanently connected to the stepped shaft 40 engages a gear wheel 43 which is fastened to the motor shaft of the servomotor 24. To drive the fuser roller 21, the gear wheel 41 engages a gear wheel 44 which is fastened to the fuser roller 21. The fuser roller 21 is rotationally mounted by means of two graphite bearings 51 on a heating cartridge 50 of the prior art. The heating cartridge 50 is supported on a disc 26.

The fuser roller 21 is therefore driven by the servomotor by means of the gear wheels 43 and 53, the stepped shaft 40, the freewheel mechanism and the gear wheels 41 and 44. On the gearwheel 41, as shown in FIG. 10, sits a straight pin 56, to which the initiator 46 responds. The initiator 46 is realized particularly in the form of an inductive proximity sensor. This proximity sensor reacts to the straight pin 56. As soon as the initiator 46 is on the straight pin 56, the servomotor 24 is turned off. The servomotor is then in the standby position. When a substrate 5 passes over the sensor 52 indicated in FIG. 11, the servomotor 24 rotates into an initial position which is the starting position. The fuser roller 21 is then ready for the application of at least one security film 5 on the substrate S.

The above mentioned displacements of the carrier 22 and thus of the fuser roller 21 are accomplished by a feed motor 45 which has a threaded rod 54, which is connected by means of a nut 55 with the carrier 23. As a result of the rotation of the threaded rod 54, the carrier 23 is moved toward or away from the counter-pressure roller 36 illustrated in FIG. 11.

As illustrated schematically in FIG. 11, the fuser roller 21 has at least two segments 30, each of which has a flexible coating 35 made of rubber, for example, and which by means of an external surface 27 each segment heats the film strip F in a strip-shaped area and presses it onto a substrate S, thereby applying a security film 5 to the substrate S. The flexible layers 35 are attached to a support part 29 which has a lateral overhang. The security film, however, can also be transferred with a metal roller without a flexible coating. The fuser roller 21 thereby rotates in synchronization with the substrate S, which moves past it tangentially and is guided on transport rollers 37. The film strips F travel at the same speed as the substrate S, which is supported on a counter-pressure roller 36. The film strip F is paid out from a roller 38 and wound up on a roller 39. When the security film 5 has been applied to the substrate S, this film is removed from the carrier 33 together with the substrate S. In the exemplary embodiment illustrated in FIG. 11, two security films 5a and 5b are deposited on the substrate S. The distance B (FIG. 3) equals the distance between neighboring segments of the fuser roller 21.

The substrate S is personalized as described above and is placed in the lamination device 20 for the application of the security film 5a, 5b. As soon as the sensor 52 (FIG. 11) reports that a substrate S is present, the fuser roller 21 is rotated as described above by the servomotor 24 into a starting position. When the substrate S reaches the level of the heated fuser roller 21, the fuser roller 21 is moved toward the substrate S with the feed motor 45. As a result of the pressure of the counter-pressure roller 36, the substrate S is moved along with it. The freewheel mechanism 42, 16 prevents the servomotor 24 from moving. A short time later, the servomotor 24 is turned on and assumes the same speed as the substrate S. This is achieved before the heated fuser roller 21 reaches a first free position in the axial direction. When the fuser roller 21 is in the free position, it is no longer in contact with the substrate S, and the drive is interrupted. In this position, the servomotor 24 guarantees the further drive of the fuser roller 21. The fuser roller 21 thereby still has the same speed as the substrate S, and thus the gap width is always the same. After the fuser roller 21 is in the free position, the fuser roller 21 is once again in contact with the substrate S. When the second free position has been reached, the fuser roller 21 moves back. The substrate S with the laminated security films 5a and 5b is then transported to another station and the lamination device 20 is ready for another substrate.

The direct drive of the fuser roller 21 by the servomotor 24 has the advantage that the fuser roller 21 does not stop when it loses contact with the substrate S. The drive of the fuser roller 21 can thereby be synchronized with the movement or the speed of the substrate S being processed.

A registration of the fuser roller 21 in a control system not shown here ensures that the positioning of the security film 5 or the security films 5a and 5b to be transferred to the surface of the substrate of the substrate S is identical on each data medium. After each application of a security film 5, the fuser roller 21 is moved into the idle position. The fuser roller 21 can be replaced, for example, by a roller that has more or less than two segments.

1. Card-format data medium (1, 1′) with a substrate (S) which has an upper surface (10) with means (D) for visual personalization and an encircling narrow edge (32), with at least one transparent protection layer (6) and a transparent security film (5, 5a, 5b) located under said transparent protection layer, which security film is applied evenly to the top surface (10) of the substrate (S) and covers said means (D), characterized by the fact that the above mentioned means (D) are located inside an unoccupied free edge (10a) of the upper surface (10) of the substrate (S) and the transparent security film (5, 5a, 5b) covers these means (D) inside the unoccupied edge (10a) and the transparent protection film (5, 5a, 5b) is directly bonded to the substrate (S) in the area of the unoccupied edge (10a).

2. Data medium as claimed in claim 1, characterized by the fact that the security film (5, 5a, 5b) consists of a plurality of parts (5a, 5b), which are bonded to the substrate (4) at some distance from each other and that the transparent protection layer (6) is also bonded evenly with the substrate (4) between the parts (5a, 5b) in an area (16b).

3. Data medium as claimed in claim 2, characterized by the fact that the security film, (5) consists of two parts (5a, 5b), between which a strip-shaped area (16b) exists, in which the transparent protection layer (6) is bonded directly to the substrate (S).

4. Data medium as claimed in one of the claims 1 to 3, characterized by the fact that the transparent protection layer (6) covers the substrate (S) over its entire surface and is flush with or at a distance of 1 to 1.5 mm from the narrow edge (32).

5. Data medium as claimed in one of the claims 1 to 4, characterized by the fact that the above mentioned means (D) for personalization have printing (D), in particular a thermal transfer printing or thermal sublimation printing.

6. Data medium as claimed in one of the claims 1 to 5, characterized by the fact that the edge (6a, 6a′) with which the transparent protection layer (6) projects beyond the security film (5) has a width (B) which is less than 10 mm, preferably less than 8 mm.

7. Data medium as claimed in claim 6, characterized by the fact that the width (B) of the area (6a, 6a′) is 4 to 6 mm.

8. Method for the manufacture of a card-format data medium, whereby a top surface (10) of a substrate (S) is personalized and the personalized area (D) is covered with a security film (5, 5a, 5b) and this security film is in turn covered with a transparent protection layer (6), characterized by the fact that an unoccupied edge (10a) of the above mentioned top surface (10) is essentially not personalized and particularly not printed, and that the security film (5, 5a, 5b) is applied so that it is located inside the top surface (10) of the substrate (S) at some distance from one narrow edge (32) of the substrate (S) and leaves the above mentioned unoccupied edge (10a) free and the protection layer (6) is bonded directly to the substrate (S) in the area of the unoccupied edge (10a).

9. Method as claimed in claim 7, characterized by the fact that the security film (5, 5a, 5b) is laminated onto the substrate (S) by means of a roller (21) using the stamping principle.

10. Method as claimed in claims 7 or 8, characterized by the fact that two or more security films (5a, 5b) are deposited on the substrate (S), whereby these films (5a, 5b) are positioned with respect to the top surface (10) of the substrate (S) so that between these security films (5a, 5b), after the application, there is an unoccupied area (10b), and in this unoccupied area the protection layer (6) is bonded directly to the substrate (S).

11. Method as claimed in one of the claims 8 to 10, characterized by the fact that the substrate (S) is guided between a driven roller (21) and a counter-pressure roller (36) for the lamination of the security film (5, 5a, 5b).

12. Method as claimed in one of the claims 9 to 11, characterized by the fact that the roller (21) is heated and the security film (5, 5a, 5b) is bonded to the substrate (S) at an elevated temperature.

13. Lamination device for the manufacture of card-format data media with a fuser roller (21) and a counter-pressure roller (36), between which a film strip (F) and substrate (S) are transported, whereby the substrate (S) is laminated on the printed side with a security film (5, 5a, 5b) which is separated from the film strip (F), with transport means for the film strip (F) and the substrate (S), characterized by the fact that the fuser roller (21) is driven.

14. Lamination device as claimed in claim 13, characterized by the fact that the fuser roller (21) has at least one segment on its periphery.
